(19) United States
(12) Patent Application Publication
(10) Pub. No.: US 2026/0139172 A1
(43) Pub. Date: May 21, 2026

(54) PHOTOCURABLE RESIN COMPOSITION FOR DISPLAY DEVICE, AND DISPLAY DEVICE

(71) Applicant: Denka Company Limited, Tokyo (JP)

(72) Inventors: Yuki HISHA, Chuo Tokyo (JP); Misato KOBAYASHI, Chuo Tokyo (JP); Hideaki TAKASE, Chuo Tokyo (JP)

(21) Appl. No.: 19/123,375

(22) PCT Filed: Oct. 20, 2023
(86) PCT No.: PCT/JP2023/037980

§ 371 Date: Apr. 22, 2025

(30) Foreign Application Priority Data
Oct. 25, 2022 (JP) 2022-170472

(51) Int. Cl. C09J 181/02; B32B 7/023; B32B 7/12; B32B 17/06; C08G 75/045

(52) U.S. Cl. CPC C09J 181/02; B32B 7/023; B32B 7/12; B32B 17/06; C08G 75/045; B32B 2250/02; B32B 2307/418; B32B 2457/20

(57) ABSTRACT

To provide a photocurable resin composition for a display device, wherein adjusting a refractive index more finely enables preparation of a resin cured product layer having a small refractive index difference compared to various light-transmitting members. Further, to provide a display device in which various materials can be selected as light-transmitting members, and decreases in visibility due to external light being reflected are suppressed. Provided is a photocurable resin composition for a display device, the photocurable resin composition including: a prepolymer which is a reactant of a polyene and a polythiol and has in its structure a carbon-carbon double bond and a mercapto group; and a photopolymerization initiator. Provided is a display device having laminated therein, sequentially, an image display member, a resin cured product layer, and a light-transmitting member, the resin cured product layer configured from a resin cured product including a reactant of a polyene and a polythiol.

### TECHNICAL FIELD

The present invention relates to: a photocurable resin composition for a display device; and a display device.

### BACKGROUND

In display devices such as liquid crystal display panels, etc., used in information terminals such as smart phones, and the like, first a photocurable resin composition layer is formed by disposing a photocurable resin composition between an image display member such as a liquid crystal display panel or an organic EL panel, etc., and a light-transmitting optical member. Curing is then performed by irradiating light at the photocurable resin composition layer to form a resin cured product layer. In such a manner, display devices are produced by using the resin cured product layer described above to bind/laminate an image display member and a light-transmitting member (for example, Patent Document 1, etc.). Configuring in such a manner enables gaps between the image display member and the light-transmitting member to be filled and prevents decreases in visibility caused by decreases in brightness or contrast, etc., due to diffused reflection of external light.
Patent Document 1: JP 5411394 B

### SUMMARY OF INVENTION

However, for resin cured product layers obtained from conventional photocurable resin compositions, there is a large difference in refractive indexes compared to the light-transmitting member, and thus, the effect of suppressing a decrease in visibility due to the reflection of external light is insufficient. Furthermore, in recent years, from the viewpoint of making display devices lighter and thinner, various kinds of films and glass materials have been proposed as light-transmitting members. Due thereto, when the breadth of selection for light-transmitting members is taken into consideration, there is demand for a photocurable resin composition in which adjustment of the refractive index can be performed more finely.

Here, an objective of the present invention is to provide a photocurable resin composition for a display device, wherein by adjusting the refractive index more finely, it is possible to prepare a resin cured product layer having a small refractive index difference compared to various kinds of light-transmitting members. Furthermore, an objective of the present invention is also to provide a display device in which it is possible to select various kinds of materials as a light-transmitting member and in which a decrease in visibility due to external light being reflected is suppressed.

As a result of diligent research, the inventors of the present application discovered that with a photocurable resin composition including a specific prepolymer, which is a reactant of a polyene and a polythiol, adjustment of the refractive index can be performed more suitably, leading to the completion of the present invention.

That is, the present invention has the following aspects.

[1] A photocurable resin composition for a display device, the photocurable resin composition including: a prepolymer which is a reactant of a polyene and a polythiol and has in the structure thereof a carbon-carbon double bond and a mercapto group; and a photopolymerization initiator.
[2] The photocurable resin composition for a display device described in [1], wherein the refractive index is 1.50-1.60 when cured under the following conditions:
(curing conditions)
the photocurable resin composition is poured into a formwork so as to have a thickness of 1 mm, and is then cured by being irradiated with light, using a light source having a central wavelength of 365 nm, so that the accumulated light amount is 3,000 mJ/cm² or more.
   [3] The photocurable resin composition for a display device described in [1] or [2], wherein the photocurable resin composition has a viscosity of 10-50,000 mPa·s/25° C.
   [4] A cured product of the photocurable resin composition for a display device described in any of [1] to [3].
   [5] A display device having laminated therein, in order, an image display member, a resin cured product layer, and a light-transmitting member,
the resin cured product layer being configured from a resin cured product including a reactant of a polyene and a polythiol.
   [6] The display device described in [5], wherein: the light-transmitting member is laminated directly on the resin cured product layer; and
a difference in refractive indexes between the resin cured product layer and the light-transmitting member is 0.05 or less.
   [7] The display device described in [5] or [6], wherein the resin cured product layer is configured from the cured product described in [4].
   [8] A laminated body provided with the cured product described in [4] and a light-transmitting member.
   [9] The laminated body described in [8], wherein the cured product is laminated directly on at least one surface of the light-transmitting member.
   The laminated body described in [8] or [9], wherein a difference in refractive indexes between the light-transmitting member and the cured product is 0.05 or less.

According to the present invention, it is possible to provide a photocurable resin composition for a display device, wherein by adjusting the refractive index more finely, it is possible to prepare a resin cured product layer having a small refractive index difference compared to various kinds of light-transmitting members. Furthermore, the present invention can also provide a display device in which it is possible to select various kinds of materials as a light-transmitting member and in which a decrease in visibility due to external light being reflected is suppressed.

### BRIEF DESCRIPTION OF DRAWINGS

FIG. 1 is section view showing an example of a display device according to the present embodiment.

### DESCRIPTION OF EMBODIMENTS

Hereinafter, one embodiment of the present invention will be explained in detail. The present invention is not limited to the embodiment below and can be implemented by adding modifications, as appropriate, within a range that does not inhibit the effects of the present invention. When a specific explanation regarding one embodiment also applies to another embodiment, there are cases in which the explanation is omitted for the other embodiment. The expression “X-Y” indicating numerical ranges in the present specification means “X or more and Y or less”.

### [Photocurable Resin Composition for Display Device]

A photocurable resin composition for a display device according to the present embodiment includes: a prepolymer which is a reactant of a polyene and a polythiol and has in the structure thereof a carbon-carbon double bond and a mercapto group; and a photopolymerization initiator. According to the photocurable resin composition for a display device according to the present invention, by adjusting the refractive index more finely, it is possible to prepare a resin cured product layer having a small refractive index difference compared to various kinds of light-transmitting members.

Note that “photocurable resin composition” refers to a resin composition in which a curing reaction proceeds by light irradiation. Herein, “photocurable resin composition” indicates a resin composition before performing light irradiation for a curing reaction. Further, “resin cured product” or “cured product” indicates a resin in which a curing reaction has proceeded by irradiating light at the photocurable resin composition. Further, “resin cured product” and “cured product” include a semi-cured product of the resin composition. “Semi-cured product” means a resin composition in a state of being cured to an extent at which there is no longer any fluidity, and indicates a state in which curing will proceed further by irradiating light.

### <Prepolymer>

The photocurable resin composition for a display device according to the present embodiment (hereinafter, referred to simply as the “resin composition”) includes a prepolymer which is a reactant of a polyene and a polythiol and has in the structure thereof a carbon-carbon double bond and a mercapto group. In general, a “prepolymer” indicates a polymer which has two or more different monomers and which has a polymerizible functional group in the structure thereof. In the present embodiment, as described above, a prepolymer indicates a polymer which is obtained by reacting a polyene and a polythiol and which has in the structure thereof a carbon-carbon double bond and a mercapto group.

### (Polyene)

In the present embodiment, a polyene refers to a polyfunctional compound having two or more carbon-carbon double bonds in one molecule. Examples of polyenes include allyl alcohol derivatives, polyfunctional esters of (meth)acrylic acid and a polyhydric alcohol, polyfunctional urethane (meth)acrylate, and divinylbenzene, etc. The foregoing may be used alone or as a combination of two or more. Herein, (meth)acrylate means both acrylate and methacrylate.

Examples of the allyl alcohol derivatives include triallyl isocyanurate, triallyl cyanurate, diallyl maleate, diallyl fumarate, diallyl adipate, diallyphthalate, triallyl trimellitate, tetraallyl pyromellitate, glycerin diallyl ether, trimethylolpropane diallyl ether, pentaerythritol diallyl ether, and sorbitol diallyl ether, etc. The foregoing allyl alcohol derivatives may be used alone or as a combination of two or more.

As the polyhydric alcohol in the polyfunctional esters of (meth)acrylic acid and a polyhydric alcohol, a polyhydric alcohol in which the number of hydroxyl groups is 2-6 is preferable. Specific examples include ethylene glycol, propylene glycol, 1,4-butanediol, 1,6-hexanediol, glycerin, trimethylolpropane, pentaerythritol, and sorbitol, etc. The foregoing may be used alone or as a combination of two or more. Note that herein, (meth)acrylic acid means both methacrylic acid and acrylic acid.

Among the foregoing, from the perspective of reactivity with a polythiol, including an allyl alcohol derivative is preferred, including at least one selected from the group consisting of triallyl isocyanurate, triallyl cyanurate, and diallyl maleate is more preferred, and including triallyl isocyanurate or diallyl maleate is even more preferred.

### (Polythiol)

In the present embodiment, a polythiol refers to a polyfunctional compound having two or more mercapto groups (SH groups) in one molecule. Examples of polythiols include polyfunctional esters of a mercapto carboxylic acid and a polyhydric alcohol, aliphatic polythiols, and aromatic polythiols, etc. The foregoing may be used alone or as a combination of two or more.

Among the polyfunctional esters of a mercapto carboxylic acid and a polyhydric alcohol, examples of the mercapto carboxylic acid preferably used include thioglycolic acid, α-mercaptopropionic acid, and β-mercaptopropionic acid, etc. The foregoing may be used alone or as a combination of two or more.

Further, as the polyhydric alcohol, a polyhydric alcohol in which the number of hydroxyl groups is 2-6 is preferable. Specific examples include ethylene glycol, propylene glycol, 1,4-butanediol, 1,6-hexanediol, glycerin, trimethylolpropane, pentaerythritol, and sorbitol, etc. The foregoing may be used alone or as a combination of two or more.

Examples of the alihpatic polythiols and aromatic polythiols include ethanedithiol, propanedithiol, hexamethylenedithiol, decamethylene dithiol, tolylene 2,4-dithiol, and xylenedithiol, etc. The foregoing may be used alone or as a combination of two or more.

Among the foregoing, from the perspective of less odor, including polyfunctional esters of a mercapto carboxylic acid and a polyhydric alcohol is preferred and including polyfunctional esters of β-mercaptopropionic acid and a polyhydric acid is more preferred.

With respect to the reaction ratio of the polyene and the polythiol in the prepolymer according to the present embodiment, it is preferable for the polyene and the polythiol to be reacted so that the molar ratio of carbon-carbon double bond groups in the polyene and mercapto groups in the polythiol (carbon-carbon double bond groups: mercapto groups) is 5:1-1:5, and more preferably to be reacted so that said molar ratio is 1:1. If the reaction ratio is within the range 5:1-1:5, it is easy to suppress the cured product of the resin composition according to the present embodiment from becoming too hard, and thus, brittle. Further, since curing time is not too long, handling is also easier.

When the molar ratio is in the range 5:1-2:1, that is, when the polyene and polythiol are reacted with the ratio of the polyene being high, the refractive index of a cured product of the obtained resin composition is likely to be low. Meanwhile, when the molar ratio is in the range 1:2-1:5, that is, when the polyene and polythiol are reacted with the ratio of the polythiol being high, the refractive index of a cured product of the obtained resin composition is likely to be high.

In the present disclosure, the ratio of the carbon-carbon double bonds and the mercapto groups in the prepolymer included in the resin composition can be adjusted in accordance with adjustment of the reaction ratio (molar ratio) of the polyene and the polythiol during production of the prepolymer, the reaction temperature, and/or the reaction time. Further, in the present disclosure, the presence or absence of carbon-carbon double bonds in the prepolymer may be evaluated by the presence or absence of carbon-carbon double bonds from an amount of the polythiol after confirming an amount of unreacted polythiol included in the prepolymer by tritration, and also may be confirmed by IR analysis of the prepolymer. Similarly, the presence or absence of mercapto groups in the prepolymer may be confirmed by iodine titration and may also be confirmed by IR analysis (same method as that used for the carbon-carbon double bonds) of the prepolymer.

In one embodiment, the viscosity of the prepolymer is preferably 10-50,000 mPa·s/25° C., more preferably 100-48,000 mPa·s/25° C., even more preferably 150-45,000 mPa·s/25° C., and particularly preferably 200-40,000 mPa·s/25° C. If the viscosity of the prepolymer is 50,000 mPa·s/25° C. or less, there is unlikely to be a decrease in workability since a step for warming the polymer does not become excessive. Further, if the viscosity of the prepolymer is 10 mPa·s/25° C. or more, there is unlikely to be a decrease in workability since leakages in an application step are not likely to occur. Further, if the viscosity of the prepolymer is high, the refractive index of a cured product of the resin composition is likely to be high. In one embodiment, from the viewpoint that it is easy to obtain a cured product having a relatively low refractive index, the viscosity of the prepolymer may be 10 mPa·s/25° C. or more and less than 5,000 mPa·s/25° C. In another embodiment, from the viewpoint that it is easy to obtain a cured product having a relatively high refractive index, the viscosity of the prepolymer may be 5,000-50,000 mPa·s/25° C. Besides controlling the reaction time or the reaction temperature, the viscosity of the prepolymer may be adjusted by adding a reaction terminating agent. Note that the viscosity of the prepolymer can be measured by an E-type viscometer under conditions with a liquid temperature of 25° C.

### (Method for Producing Prepolymer)

The prepolymer according to the present embodiment can be prepared by mixing a polyene and a polythiol and causing the mixture of the polyene and the polythiol to react until a desired viscosity is achieved.

Examples of the method for causing the mixture of polyene and polythiol to react include methods in which the mixture is heated and methods in which a small amount of a photopolymerization initiator is added and ultraviolet light is irradiated. From the perspective of being able to control the reaction rate easily, a method in which the mixture is heated is preferred.

Examples of methods in which the mixture is heated include a method in which the mixture is caused to react by being heated, from the viewpoint of being able to the control reaction rate easily, preferably at 20-70° C. and more preferably at 30-60° C., and when a desired viscosity is reached, a reaction terminating agent is added to terminate the reaction. By adding a reaction terminating agent, the viscosity of the prepolymer can be adjusted more easily.

As described above, with respect to the mixing ratio (reaction ratio) of the polyene and the polythiol, it is preferable for the polyene and the polythiol to be mixed so that the molar ratio of carbon-carbon double bond groups in the polyene and mercapto groups in the polythiol (carbon-carbon double bond groups:mercapto groups) is 5:1-1:5, and more preferably to be mixed so that said molar ratio is 1:1.

Examples of reaction terminating agents include N-nitrosophenyl hydroxylamine ammonium salt, 2,6-di-tert-butyl-4-methylphenol, 2,2-methylene-bis(4-methyl-6-tert-butylphenol), hydroquinone, and monomethyl ether, etc. Among the foregoing, N-nitrosophenyl hydroxylamine ammonium salt is preferable from the perspective that a significant effect is easily obtained with a small usage amount.

From the perspective of controlling reaction rate, the usage amount of the reaction terminating agent is preferably 0.001-1.0 parts by mass and more preferably 0.03-0.1 parts by mass with respect to 100 parts by mass of the total of the polyene and the polythiol. If the usage amount of the reaction terminating agent is within the above ranges, it is easy to control the reaction rate and the viscosity of the prepolymer, and it becomes easier to prevent the resin composition from yellowing over time.

### <Photopolymerization Initiator>

The resin composition according to the present embodiment includes a photopolymerization initiator. By including a photopolymerization initiator, the resin composition can be cured by being irradiated with light.

As long as the effects of the present invention are exhibited, the photopolymerization initiator is not particularly limited and a conventional and publicly-known photopolymerization initiator may be employed. Examples of the photopolymerization initiator include: benzophenone-based photopolymerization initiators such as benzophenone, methyl ortho-benzoylbenzoic acid, and 4-benzoyl-4′-methyldiphenyl sulfide, etc.; acetophenone-based photopolymerization initiators such as acetophenone, benzyl dimethyl ketal, 2-hydroxy-2-methyl-1-phenylpropane-1-one, and 2-methyl-1-[4-(methylthio)phenyl]-2-morpholinopropane-1, etc.; benzoin ether-based photopolymerization initiators such as benzoin methyl ether, benzoin ethyl ether, benzoin isopropyl ether, and benzoin isobutyl ether, etc.; thioxanthone acylphosphine oxides such as isopropylthioxanthone and diethylthioxantone, etc.; benzyl; camphorquinone; anthraquinone; and Michler's ketone, etc. The foregoing photopolymerization initiators may be used alone or as a combination of two or more. Among the foregoing, from the perspective of yellowing resistance of the obtained cured product, including a benzoin ether-based photopolymerization initiator is preferred and including benzoin ethyl ether is more preferred.

The content of the photopolymerization initiator is preferably 0.001-10 parts by mass and more preferably 0.05-1 parts by mass with respect to 100 parts by mass of the total of the polyene and the polythiol. If the content of the photopolymerization initiator is within the above ranges, the curing speed of the resin composition is likely to be suitable and it is easy to prevent temporal yellowing of the resin composition.

### <Other Components>

The resin composition according to the present embodiment may include a prepolymer and a component (other component) other than a photopolymerization initiator. Examples of the other component include adhesion improving agents such as coupling agents, organosilicon compounds, etc., reaction terminating agents, anti-aging agents, polymerization inhibitors, fillers, colorants, thixotropy agents, curing accelerators, plasticizers, and surfactants, etc. The foregoing may be used alone or as a combination of two or more. The reaction terminating agent may be an agent (the reaction terminating agent described above) that is added during production of the prepolymer. Among the foregoing, from the viewpoint of improving adhesion, including a coupling agent is preferred.

Examples of the coupling agent include silane coupling agents, titanate coupling agents, zirconate coupling agents, and organic aluminum coupling agents, etc. Among the foregoing, from the viewpoint that it is easy to improve adhesion, a silane coupling agent is preferred.

Examples of silane coupling agents include γ-glycidoxypropyltrimethoxysilane, γ-glycidoxypropyl methyldiethoxysilane, N-(β-aminoethyl)-γ-aminopropyl trimethoxysilane, N-(β-aminoethyl)-γ-aminopropyl methyldimethoxysilane, γ-aminopropyl triethoxysilane, N-phenyl-γ-aminopropyl trimethoxysilane, γ-mercaptopropyl trimethoxysilane, γ-chloropropyl trimethoxysilane, β-(3,4-epoxycyclohexyl)ethyl trimethoxysilane, and vinyl-tris(β-methoxyethoxy)silane, etc. Among the foregoing, from the perspective of adhesion, including vinyl-tris(β-methoxyethoxy)silane is preferred.

When a silane coupling agent is included as another component, the usage amount of the silane coupling agent is preferably 0.01-2 parts by mass and more preferably 0.1-1 parts by mass with respect to 100 parts by mass of the total of the polyene and the polythiol. If the usage amount of the silane coupling agent is within the foregoing ranges, adhesion is likely to be good and other physical properties of the cured product are unlikely to decrease.

In one embodiment, the viscosity of the resin composition is preferably 10-50,000 mPa·s/25° C., more preferably 100-48,000 mPa·s/25° C., even more preferably 150-45,000 mPa·s/25° C., and particularly preferably 200-40,000 mPa·s/25° C. If the viscosity of the resin composition is within the foregoing ranges, the refractive index of a cured product of the resin composition is likely to be a value close to that of the light-transmitting member. Note that the viscosity of the resin composition can be measured by an E-type viscometer under conditions with a liquid temperature of 25° C.

In one embodiment, the refractive index, when the resin composition is cured under the conditions described below, is preferably 1.50-1.60, more preferably 1.52-1.59, and even more preferably 1.53-1.58.

### (Curing Conditions)

The photocurable resin composition is poured into a formwork so as to have a thickness of 1 mm and is then cured by being irradiated with light, using a light source having a central wavelength of 365 nm, so that the accumulated light amount is 3,000 mJ/cm² or more.

The refractive index of the resin composition of the present embodiment can be adjusted finely. In one embodiment, the refractive index of the resin composition, when cured under the above curing conditions, is preferably in the range of 1.50-1.60. If the refractive index can be finely adjusted within the above range, the difference in refractive indexes when compared with light-transmitting members currently employed in display devices is easily reduced and display device visibility can easily be improved. Note that the refractive index of the resin composition can be determined by using an Abbe refractometer under conditions of 25° C. to measure a resin composition cured under the above conditions.

### <Cured Product of Photocurable Resin Composition>

By irradiating light onto the resin composition according to the present embodiment, the carbon-carbon double bonds and the mercapto groups in the prepolymer undergo addition polymerization to form a cured product. Photocuring can be performed, for example, by using a high-pressure mercury lamp, a low-pressure mercury lamp, a metal halide lamp, a fluorescent chemical lamp, a fluorescent blue lamp, or an LED lamp, etc., as a light source to irradiate the resin composition with light so that the accumulated light amount is 300-5,000 mJ/cm².

In one embodiment, the refractive index of a cured product obtained by curing the resin composition under the conditions described above is preferably in the range of 1.50-1.60. If the refractive index of the cured product can be finely adjusted within the above range, the difference in refractive indexes when compared with light-transmitting members currently employed in display devices is easily reduced and display device visibility can easily be improved. The refractive index of the cured product can be determined by using an Abbe refractometer under conditions of 25° C. to measure a cured product with a 1 mm thickness.

In one embodiment, the adhesive strength of a cured product of the resin composition is preferably 0.1-20 MPa and more preferably 1-10 MPa. If the adhesive strength of the cured product is within the above ranges, sufficient adhesive strength is likely to be exhibited when used for a display device. Note that the adhesive strength refers to tensile shear adhesive strength and can be measured under the conditions described below.

### (Method for Measuring Adhesive Strength)

The tensile shear adhesive strength of the cured product of the resin composition is measured in compliance with JIS K-6850. Specifically, under conditions of a temperature of 23° C. and a humidity of 50%, the resin composition is used to stick two pieces of glass (dimensions: 12.5 mm×25 mm×1.2 mm) together and then curing by irradiating ultraviolet light at the resin composition. Thereafter, a reinforcing plate (SPCC-D steel plate, 100 mm×25 mm×1.6 mm) is adhered to both sides of the glass and a tensile testing machine is used to measure the adhesive strength at a tensile shear rate of 10 mm/min.

The adhesive strength of the cured product of the resin composition is likely to further improve by blending an appropriate amount of a coupling agent (preferably a silane coupling agent) in the resin composition.

In one embodiment, the Shore hardness of the cured product of the resin composition is preferably A-10 to D-75 and more preferably A-15 to D-70. If the Shore hardness of the cured product is within the above ranges, there are unlikely to be any adverse affects on the performance of a display device. Note that the Shore hardness can be measured under the conditions described below.

### (Method for Measuring Shore Hardness)

Curing is performed by irradiating light (with a central wavelength of 365 mm) from a high-pressure mercury lamp at the resin composition so that the accumulated light amount is 3,000 mJ/cm² to obtain a cured product with a thickness of 2 mm. Three layers of the obtained cured product are stacked on one another to form a hardness measurement sample. The Shore hardness of the sample is measured under conditions of 25° C. using a Shore durometer (for example, product name: LD05559, manufactured by TQC Ltd.).

The cured product of the resin composition according to the present embodiment is preferably light-transmissive. In one embodiment, the total light transmittance of the cured product of the resin composition is preferably 95% or more and more preferably 99% or more. If the total light transmittance of the cured product of the resin composition is 95% or more, it is easy to use the resin composition to adhere a light-transmitting member to another member such as an image display member, etc. Note that the total light transmittance can be measured under the conditions described below.

### (Method for Measuring Total Light Transmittance)

The resin composition is applied, at a film thickness of 10 μm, on glass (for example, product name: Eagle 2000®, manufactured by Corning Incorporated) with a thickness of 0.7 mm and then cured by irradiating 405 nm light from a high-pressure mercury lamp at the resin composition for 30 seconds. The total light transmittance of the obtained cured product is measured with an ultraviolet-visible spectrophotometer (for example, product name: UV-2550, manufactured by Shimadzu Corporation).

### Use

The resin composition according to the present embodiment can be used in a display device. More preferably, the resin composition according to the present embodiment can be used as a resin composition for adhering members of a display device. As described above, by finely adjusting the refractive index, the resin composition according to the present invention can provide a cured product having a refractive index close to that of a light-transmitting member. Due thereto, the resin composition according to the present embodiment is particularly preferably used as a resin composition for forming a resin cured product layer that adheres a light-transmitting member of a display device to another member thereof.

Another aspect of the resin composition according to the present embodiment is a use of a photocurable resin composition as an optical adhesive for a display device, or a method of using the optical adhesive. In the case of being used as an optical adhesive for a display device, the resin composition according to the present embodiment is, for example, coated on a member (preferably a light-transmitting member) constituting the display device by an arbitrary method and then another member is laminated on the resin composition. Thereafter, the resin composition is cured by irradiating light at the resin composition (for example, using a light source having a central wavelength of 365 nm to irradiate light at the resin composition from the light-transmitting member side so that the accumulated light amount is 3,000 mJ/cm² or more). By using a method including the foregoing steps, it is possible to use the resin composition according to the present embodiment as an optical adhesive for a display device.

Further, another aspect of the resin composition according to the present embodiment is a use of a photocurable resin composition as a refractive index adjuster for a display device or a method of using the refractive index adjuster. In the case of being used as refractive index adjuster for a display device, the resin composition according to the present embodiment is, for example, coated on an arbitrary optical adhesive. Thereafter, a light-transmitting member is also laminated as necessary, and curing is then performed by irradiating light at the resin composition (for example, using a light source having a central wavelength of 365 nm to irradiate light at the resin composition from the light-transmitting member side so that the accumulated light amount is 3,000 mJ/cm² or more). By using a method including the foregoing steps, it is possible to adjust the difference in refractive indexes between a light-transmitting member and an optical adhesive by laminating a layer (resin cured product layer) formed from a cured product of the resin composition of the present embodiment on a conventional optical adhesive.

### [Display Device]

The display device according to the present embodiment has laminated therein, in order, an image display member, a resin cured product layer, and a light-transmitting member, the resin cured product layer being configured from a resin cured product including a reactant of a polyene and a polythiol. According to the present embodiment, it is possible to provide a display device in which it is possible to select various kinds of materials as a light-transmitting member and in which a decrease in visibility due to external light being reflected is suppressed. Note that being a reactant of a polyene and a polythiol is preferred from the perspective that there is likely to be a small difference in refractive indexes when compared to the light-transmitting member.

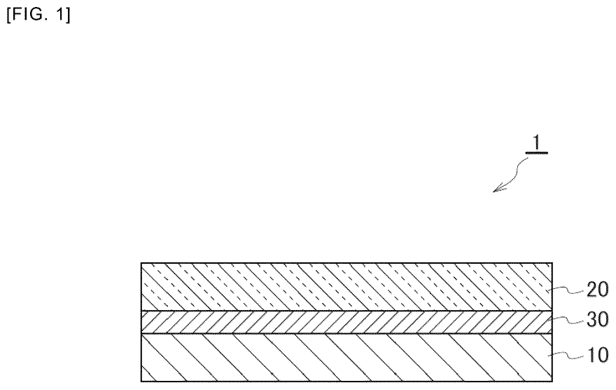

FIG. 1 is section view showing an example of a display device according to the present embodiment. In FIG. 1, a display device 1 has laminated therein, in order, an image display member 10, a resin cured product layer 30, and a light-transmitting member 20. The display device 1 in FIG. 1 has a simple configuration having only the image display member 10, the resin cured product layer 30, and the light-transmitting member 20. However, a polarization plate or an adhesive layer, etc., may also be provided between the image display member 10 and the resin cured product layer 30. Further, it is also possible to set a configuration in which a back light is laminated on the opposite side of the image display member 10 to the side on which the resin cured product layer 30 is laminated. Furthermore, there may also be a configuration in which a spacer is disposed between the image display member 10 and the light-transmitting member 20 to provide a void between the image display member 10 and the light-transmitting member 20, and the resin cured product layer 30 is filled in the void.

### <Image Display Member>

The display device according to the present embodiment is provided with an image display member. Examples of the image display member include a liquid crystal display (LCD) panel, an organic EL display (OLED) panel, an electroluminescent display (ELD) panel, a field emission display (FED) panel, and a plasma display panel (PDP), etc.

### <Resin Cured Product Layer>

The display device according to the present embodiment is provided with a resin cured product layer. The resin cured product layer according to the present embodiment includes a reactant of a polyene and a polythiol. As described above, a polyene indicates a polyfunctional compound having two or more carbon-carbon double bonds in one molecule, and a polythiol indicates a polyfunctional compound having two or more thiol groups in one molecule. The reactant of a polyene and a polythiol may, for example, include a constituent unit represented by “—S—CH₂—CH₂—” in the molecular structure. By being provided with such a resin cured product layer, it is possible to select various kinds of materials as a light-transmitting member and to suppress a decrease in visibility due to external light being reflected. Note that it is possible to confirm the presence or absence of a reactant of a polyene and a polythiol by analyzing the resin cured product layer by a titration method or an IR method, etc.

The resin cured product layer is preferably configured from a cured product of the resin composition according to the present embodiment. In the case of being a cured product of the resin composition described above, it is easy to adjust the refractive index in accordance with the light-transmitting member, and thus, it is easy to achieve a display device having better visibility. Note that although the cured product of the present disclosure also includes a semi-cured product, the resin cured product layer of the display device according to the present embodiment is preferably not a semi-cured product. That is, the resin cured product layer of the display device according to the present embodiment is preferably a cured product which has been completely cured by light irradiation. Note that “cured product which has been completely cured” indicates a cured product which does not undergo further curing even if the cured product is irradiated with light. In one embodiment, the “cured product which has been completely cured” may include a cured product which is substantially free of unreacted carbon-carbon double bonds and/or mercapto groups. Further, “substantially free of” indicates that a peak derived from carbon-carbon double bonds and/or mercapto groups is not detected when the cured product is analyzed by IR, etc.

In one embodiment, the refractive index of the resin cured product layer is preferably 1.50-1.60, more preferably 1.52-1.59, and even more preferably 1.53-1.58. If the refractive index of the resin cured product layer can be adjusted in the range of 1.50-1.60, the visibility of the display device is unlikely to decrease even when various kinds of materials are selected as the light-transmitting member. Note that if the resin cured product layer is a cured product of the resin composition according to the present embodiment, it is easy to obtain a resin cured product layer having the refractive index described above.

The resin cured product layer is preferably light-transmissive. In particular, as described later, when the resin cured product layer is laminated directly on the light-transmitting member, due to the resin cured product layer being light-transmissive, visibility is better. In one embodiment, the total light transmittance of the resin cured product layer is preferably 95% or more and more preferably 99% or more. Note that if the resin cured product layer is a cured product of the resin composition according to the present embodiment, it is easy to obtain a resin cured product layer having the total light transmittance described above.

In one embodiment, from the viewpoint of visibility, the thickness of the cured resin layer is preferably 0.1-70 μm and more preferably 5-50 μm. The thickness of the resin cured product layer can be measured by observing a cross-section of the display device with a microscope, or the like.

### <Light-Transmitting Member>

The display device according to the present embodiment is provided with a light-transmitting member. As long as the light-transmitting member is a member provided with light-transmissivity that enables an image formed on the image display member to be viewed, there are no particular limitations therefor. Examples thereof include: substrates formed from an inorganic material such as glass, etc.; and substrates formed from a high-polymer material such as acrylic resin, polyethylene terephthalate, polyethylene naphthalate, polycarbonate, etc. The display device according to the present embodiment is provided with a resin cured product layer having the characteristics described above, and therefore, various kinds of materials can be selected as the light-transmitting member.

From the viewpoint that it is easy to achieve a display device having better visibility, it is preferable to set a configuration in which the light-transmitting member is laminated directly on the resin cured product layer. By having no other members (layers) between the resin cured product layer and the light-transmitting member, it is easier to adjust the refractive index, and consequently, it is easy to achieve a display device having better visibility. Further, the difference in refractive indexes between the resin cured product layer and the light-transmitting member is preferably 0.05 or less, more preferably 0.03 or less, and even more preferably 0.01 or less. Note that the difference in refractive indexes is the absolute difference.

In one embodiment, the refractive index of the light-transmitting member is preferably 1.50-1.60 and more preferably 1.53-1.59. If the refractive index of the light-transmitting member is within the ranges described above, the refractive index difference compared to the resin cured product layer is likely to be 0.05 or less and it is easy to achieve a display device having better visibility. Note that the refractive index of the light-transmitting member can be determined by performing measurement using an Abbe refractometer under conditions of 25° C.

In one embodiment, the total light transmittance of the light-transmitting member is preferably 90% or more and more preferably 95% or more. If the total light transmittance of the light-transmitting member is within the ranges described above, it is easy to achieve a display device having better visibility. Note that the total light transmittance of the light-transmitting member can be measured in accordance with the specifications of JIS K-7375.

In one embodiment, the yellowness index (YI) of the light-transmitting member is preferably 0.5 or less and more preferably 0.3 or less. If the YI of the light-transmitting member is 0.3 or less, yellowing of the light-transmitting member can be suppressed and the light-transmitting member can also easily be applied in uses demanding transparency. Note that the YI of the light-transmitting member can be measured under conditions of 25° C. by using a color meter.

In one embodiment, the haze value of the light-transmitting member is preferably 0.5% or less and more preferably 0.3% or less. If the haze value of the light-transmitting member is 0.3% or less, it is easy to suppress screen whitening. Note that the haze value of the light-transmitting member can be measured under conditions of 25° C. by using a haze meter.

Examples of the form of the light-transmitting member include plate-type and film-type members. Further, the light-transmitting member may undergo a single-sided or double-sided hard coat treatment, an anti-reflection treatment, or the like.

Further, physical properties of the light-transmitting member such as average thickness and elasticity are not particularly limited and may be determined, as appropriate, in accordance with the use objective.

In one embodiment, the light-transmitting member may have a light-shielding layer at a peripheral edge section. A light-shielding layer is provided, for example, with an objective such as improving the brightness or contrast of a display image, and design, etc. When provided, the light-shielding layer may be formed on a surface of the image display member side of the light-transmitting member.

### <Method for Producing Display Device>

The display device according to the present embodiment can be prepared by a method including: applying a photocurable resin composition for forming a resin cured product layer (application step); provisionally curing the photocurable resin composition (provisional curing step); sticking an image display member and a light-transmitting member together (sticking step); and permanently curing the resin composition after the provisional curing (permanent curing step). As one example of a method for producing the display device, there follows an explanation of a method for producing the display device 1 in FIG. 1.

### <Application Step>

The method for producing a display device according to the present embodiment includes applying a photocurable resin composition for forming a resin cured product layer. When the display device 1 of FIG. 1 is to be obtained by using the above resin composition according to the present embodiment, the resin composition described above is applied to a surface of the image display member 10 or a surface of the light-transmitting member 20. The application method is not particularly limited and a conventional publicly-known method can be employed. The resin composition may be applied to the entirety of one surface of the image display member 10 or the light-transmitting member 20, or may be applied to a portion thereof.

### <Provisional Curing Step>

After the application step, the resin composition is provisionally cured. Provisional curing is performed by irradiating light onto the resin composition described above. The provisional curing step is preferably a step in which the resin composition is rendered to a semi-cured product. That is, the resin composition is preferably cured to a degree of having no fluidity. By doing so, handling is likely to improve and there is likely to be an improvement in the uniformity of the thickness of the resin cured product layer after permanent curing. In one embodiment, in the provisional curing step, light may be irradiated at the resin composition so that the curing ratio (gel fraction) of the resin composition is 90% or more, or light may be irradiated at the resin composition so that the curing ratio (gel fraction) of the resin composition is 95% or more.

The light irradiated at the resin composition is not particularly limited and any arbitrary light may be employed. In one embodiment, provisional curing may be performed by irradiating light, using a light source having a central wavelength of 365 nm, so that the accumulated light amount is 300-3,000 mJ/cm². As the light source, it is possible to employ, for example, a high-pressure mercury lamp, a low-pressure mercury lamp, a metal halide lamp, a fluorescent chemical lamp, a fluorescent blue lamp, or an LED lamp, etc.

### <Sticking Step>

After provisionally curing the resin composition, the image display member 10 and the light-transmitting member 20 are stuck together. The method for sticking the members together is not particularly limited and may be selected, as appropriate, in accordance with the objective. For example, sticking may be carried out by pressurizing while heating at a temperature of 10° C.-80° C. using a publicly-known crimping device.

### <Permanent Curing Step>

After sticking the image display member 10 and the light-transmitting member 20 together, the resin composition is permanently cured to obtain the resin cured product layer 30. Examples of the permanent curing method include a method of curing by irradiating light at the resin composition from the light-transmitting member 20 side.

In the permanent curing step, the light irradiated at the resin composition is not particularly limited and the same light source as that used for the provisional curing may be used. In one embodiment, in the permanent curing step, curing may be performed by irradiating light, using a light source having a central wavelength of 365 nm, so that the accumulated light amount is 3,000 mJ/cm² or more.

The display device according to the present embodiment makes it possible for various kinds of materials to be selected as a light-transmitting member and can suppress a decrease in visibility due to external light being reflected. Due thereto, the display device according to the present embodiment can be used in televisions, laptop computers, tablet computers, car navigation devices, calculators, mobile phones, smart phones, electronic diaries, and PDAs (personal digital assistant), etc., which demand good visibility.

### <Laminated Body>

Another aspect of the resin composition according to the present embodiment is a laminated body provided with a cured product of the resin composition described above and a light-transmitting member. In one embodiment, it is preferable for the cured product to be directly laminated on at least one surface of the light-transmitting member. Further, the difference in refractive indexes between the light-transmitting member and the cured product is preferably 0.05 or less.

Examples of the light-transmitting member in the laminated body are the same as those described for the display device above, and preferred examples are also the same. Further, the cured product of the resin composition in the present embodiment may be a semi-cured product and may be a cured product which is completely cured. The laminated body in the present embodiment is provided with the cured product described above, and the difference in refractive indexes compared with the light-transmitting member is small. Due thereto, when used as a surface protection material in a display device, it is possible to provide a display device having good visibility.

More preferable aspects of the present invention are as described below.

<1> A photocurable resin composition for a display device, the photocurable resin composition including: a prepolymer which is a reactant of a polyene that includes an allyl alcohol derivative, and a polythiol that includes polyfunctional esters of a mercapto carboxylic acid and a polyhydric alcohol, the prepolymer having in the structure thereof a carbon-carbon double bond and a mercapto group; and a photopolymerization initiator.
<2> The photocurable resin composition for a display device described in <1>, wherein the prepolymer is a reactant obtained by reacting the polyene and the polythiol at a molar ratio (carbon-carbon double bond groups:mercapto groups) of 5:1-1:5.
<3> The photocurable resin composition for a display device described in <1> or <2>, wherein the prepolymer has a viscosity of 100-48,000 mPa·s/25° C.
<4> A method for adjusting the refractive index of a cured product of the photocurable resin composition for a display device described in any of <1> to <3>, the method including
adjusting the refractive index of the cured product in a range of 1.50-1.60 by performing any one step selected from (I)-(IV) below when preparing the prepolymer:
   (I) reacting the polyene and the polythiol at the molar ratio (carbon-carbon double bond groups:mercapto groups) of 5:1-2:1;
   (II) reacting the polyene and the polythiol at the molar ratio (carbon-carbon double bond groups:mercapto groups) of 1:2-1:5;
   (III) reacting the polyene and the polythiol so that the viscosity of the prepolymer is 10 mPa·s/25° C. or more and less than 5,000 mPa·s/25° C.; and
(IV) reacting the polyene and the polythiol so that the viscosity of the prepolymer is 5,000-50,000 mPa·s/25° C.
   <5> A method for producing a cured product having a refractive index of 1.50-1.60,
wherein: the method includes
reacting a polyene that includes an allyl alcohol derivative, and a polythiol that includes polyfunctional esters of a mercapto carboxylic acid and a polyhydric alcohol, to obtain a prepolymer having in the structure thereof a carbon-carbon double bond and a mercapto group,
adding a photopolymerization initiator to the prepolymer to obtain a photocurable resin composition, and
performing curing by irradiating the photocurable resin composition with light, using a light source having a central wavelength of 365 nm, so that the accumulated light amount is 3,000 mJ/cm² or more; and
obtaining the prepolymer includes any one step selected from (I)-(IV) below
   (I) reacting the polyene and the polythiol at the molar ratio (carbon-carbon double bond groups:mercapto groups) of 5:1-2:1,
   (II) reacting the polyene and the polythiol at the molar ratio (carbon-carbon double bond groups:mercapto groups) of 1:2-1:5,
   (III) reacting the polyene and the polythiol so that the viscosity of the prepolymer is 10 mPa·s/25° C. or more and less than 5,000 mPa·s/25° C., and
   (IV) reacting the polyene and the polythiol so that the viscosity of the prepolymer is 5,000-50,000 mPa·s/25° C.

### EXAMPLES

The present invention shall be explained in further detail by referring to the examples below, but interpretation of the present invention is not limited by these examples.

### <Production of Prepolymer>

A polyene and a polythiol were mixed so that the molar ratio of carbon-carbon double bonds in the polyene and mercapto groups in the polythiol was the ratio shown in Table 1. Thereafter, a prepolymer was prepared by reacting the mixture at the reaction temperature and for the reaction time shown in Table 1 and then adding a reaction terminator. For the obtained prepolymers 1-7, the presence or absence of carbon-carbon double bonds and the presence or absence of mercapto groups were confirmed by IR analysis. Further, the viscosity of the prepolymers was measured under the following conditions. Note that the amount (parts by mass) of the reaction terminator in Table 1 is the amount thereof blended with respect to 100 parts by mass of the total of the polyene and the polythiol.

### (Measurement of Viscosity of Prepolymer)

After adjusting the obtained prepolymers to 25° C., an E-type viscometer (product name: RE-85, manufactured by Toki Sangyo Co., Ltd.) was used to measure the viscosity.

TABLE 1

| | | | PREPOLYMER | | | | | | |
|---|---|---|---|---|---|---|---|---|---|
| | | | 1 | 2 | 3 | 4 | 5 | 6 | 7 |
| CONSTITUTION | POLYENE | (MOLAR RATIO) | 1 | 1 | 1 | 1 | 1 | 2 | 1 |
| | POLYTHIOL | (MOLAR RATIO) | 1 | 1 | 1 | 1 | 1 | 1 | 2 |
| | REACTION TERMINATOR | (PARTS BY MASS) | 0.05 | 0.03 | 0.05 | 0.05 | 0.05 | 0.1 | 0.1 |
| PRODUCTION | REACTION TEMPERATURE | (° C.) | 30 | 30 | 30 | 40 | 60 | 30 | 40 |
| CONDITIONS | REACTION TIME | (HR) | 4 | 6 | 7 | 7 | 7 | 5 | 7 |
| PHYSICAL | PRESENCE/ABSENCE OF | (—) | PRESENT | | | | | | |
| PROPERTIES | CARBON-CARBON DOUBLE | | | | | | | | |
| | BOND | | | | | | | | |
| | PRESENCE/ABSENCE OF | (—) | PRESENT | | | | | | |
| | MERCAPTO GROUP | | | | | | | | |
| | VISCOSITY | (mPa · s/25° C.) | 150 | 500 | 500 | 5,000 | 40,000 | 300 | 5,000 |

### Example 1

0.05 parts by mass of a photopolymerization initiator (benzyl dimethyl ketal, product name: Omnirad® 651, manufactured by IGM Resins) was blended with prepolymer 1 (100 parts by mass) prepared above and after being mixed for four hours at 30° C., 0.45 parts by mass of a coupling agent (vinyltris(2-methoxyethoxy)silane, product name: A-172, manufactured by Momentive) was blended with prepolymer 1 (100 parts by mass) to obtain a photocurable resin composition. The viscosity of the obtained photocurable resin composition was measured by the same method as that used for the prepolymers.

Thereafter, the refractive index, adhesive strength, Shore hardness, and total light transmittance were measured under the conditions described below. The results are shown in Table 2.

### (Measurement of Refractive Index)

The photocurable resin composition was cured under the conditions described below. Thereafter, an Abbe refractometer was used to measure the refractive index under conditions of 25° C.

### (Curing Conditions)

The photocurable resin composition was poured into a formwork so as to have a thickness of 1 mm. Then, curing was performed by irradiating light, using a light source (electrodeless discharge lamp, manufactured by Fusion Co., Ltd.) having a central wavelength of 365 nm, so that the accumulated light amount was 3,000 mJ/cm² or more.

### (Measurement of Adhesive Strength)

The photocurable resin composition obtained above was cured under the conditions described below and the adhesive strength thereof was measured. The results are shown in Table 2.

### (Measurement Method)

Measurements were carried out in compliance with JIS K-6850. Specifically, under conditions of a temperature of 23° C. and a humidity of 50%, the photocurable resin composition was used to stick two pieces of glass (dimensions: 12.5 mm×25 mm×1.2 mm) together and then cured by irradiating ultraviolet light at the resin composition. Thereafter, a reinforcing plate (SPCC-D steel plate, 100 mm×25 mm×1.6 mm) was adhered to both sides of the glass and a tensile testing machine was used to measure the tensile shear adhesive strength at a tensile shear rate of 10 mm/min.

### (Measurement of Shore Hardness)

The photocurable resin composition obtained above was cured under the conditions described below and the Shore hardness thereof was measured. The results are shown in Table 2.

### (Measurement Method)

The photocurable resin composition was poured into a 2 mm-thick silicon sheet formwork and sandwiched in a PET film. Thereafter, curing was performed by irradiating light (with a central wavelength of 365 mm) from a high-pressure mercury lamp so that the accumulated light amount was 3,000 mJ/cm² to obtain a cured product with a thickness of 2 mm. Three layers of the obtained cured product were stacked on one another to form a hardness measurement sample. The Shore hardness of the sample was measured under conditions of 25° C. using a Shore durometer (product name: LD05559, manufactured by TQC Ltd.).

### (Measurement of Total Light Transmittance)

The photocurable resin composition obtained above was cured under the conditions described below and the total light transmittance thereof was measured. The results are shown in Table 2.

### (Measurement Method)

The photocurable resin composition was applied, at a film thickness of 10 μm, on glass (product name: Eagle 2000, manufactured by Corning Incorporated) with a thickness of 0.7 mm and then cured by irradiating 405 nm light from a high-pressure mercury lamp at the resin composition for 30 seconds. Specifically, using an irradiation device (product name: UL-750, manufactured by Hoya Canedo Optronics Corporation) with a mounted high-pressure mercury lamp, light with an illuminance of 100 mW/cm² (405 nm) was irradiated for 30 seconds to cure the resin composition. The total light transmittance of the obtained cured product was measured with an ultraviolet-visible spectrophotometer (product name: UV-2550, manufactured by Shimadzu Corporation).

### <Display Device>

In order to confirm effects when the obtained resin composition is used for a display device, a plurality of light-transmitting members were prepared and the refractive index of each was measured by using the method described below. Thereafter, the differences between the refractive index of the light-transmitting members and the refractive index of the cured product of the resin composition were calculated, and cases in which the difference (absolute difference) in refractive index compared to all of the light-transmitting members was 0.05 or less were evaluated as a “pass” in that the problem of the present invention (having good visibility and enabling application to various kinds of light-transmitting members) could be solved. Meanwhile, for cases in which even only one difference in the refractive indexes exceeded 0.05, the evaluation was “fail” in that the problem of the present invention could not be solved. The results are shown in Table 2.

### (Measurement of Refractive Index of Light-Transmitting Member)

An Abbe refractometer was used to measure the refractive index of each of the light-transmitting members under conditions of 25° C.

### (Measurement of Total Light Transmittance of Light-Transmitting Member)

The total light transmittance of each of the light-transmitting members was measured in accordance with the specifications of JIS K-7375.

### (Measurement of YI Value of Light-Transmitting Member)

A color meter was used to measure the YI value of each of the light-transmitting members under conditions of 25° C.

### (Measurement of Haze Value of Light-Transmitting Member)

A haze meter was used to measure the haze value of each of the light-transmitting members under conditions of 25° C.

### Examples 2-7

Other than setting the constitutions of the photocurable resin compositions so as to be as indicated in Table 2, photocurable resin compositions were prepared by the same method as that for Example 1. After measuring the viscosity of the obtained resin compositions by the same method as in Example 1, the refractive index, adhesive strength, Shore hardness, and total light transmittance were measured by the same methods as in Example 1. Furthermore, an evaluation when used in a display device was performed by the same method as in Example 1. The results are shown in Table 2.

### Comparative Example 1

3 parts by mass of a photopolymerization initiator were blended with 100 parts by mass of acrylic polymer 1 (mixture obtained by mixing, at 70:30, urethane acrylate (product name: UN9200, manufactured by Mitsubishi Chemical Group Corporation) and a nonylphenol EO-modified acrylate (product name: M-113, manufactured by Toagosei Co., Ltd.) to obtain an acrylic photocurable resin composition. After measuring the viscosity of the obtained acrylic photocurable resin composition by the same method as in Example 1, the refractive index, adhesive strength, Shore hardness, and total light transmittance were measured by the same methods as in Example 1. Furthermore, an evaluation when used in a display device was performed by the same method as in Example 1. The results are shown in Table 2.

### Comparative Examples 2 and 3

Other than using the acrylic polymers indicated in Table 2, acrylic photocurable resin compositions were obtained by the same method as in Comparative Example 1. After measuring the viscosity of the obtained acrylic photocurable resin composition by the same method as in Example 1, the refractive index, adhesive strength, Shore hardness, and total light transmittance were measured by the same methods as in Example 1. Furthermore, an evaluation was performed when used in a display device by the same method as in Example 1. The results are shown in Table 2.

### Materials Used

Note that the materials used in the present examples are as described below.

Polyene: unrefined diallyl maleate which was distilled under reduced pressure under conditions of a boiling point of 140-180° C. (100-700 Pa) to remove metal ions.

Polythiol: unrefined trimethylol propane-tris-β-mercaptopropionate from which metal ions were removed by using a chelating agent.

Reaction terminator: N-nitrosophenyl hydroxylamine ammonium salt (product name: Cupferron, manufactured by Merck KGaA).

Coupling agent: vinyl-tris(β-methoxyethoxy)silane (product name: A-172, manufactured by Momentive).

Photopolymerization initiator: benzyl dimethyl ketal (product name: Omnirad 651, manufactured by IGM Resins).

Acrylic polymer 1: mixture obtained by mixing, at 70:30, urethane acrylate (product name: UN9200, manufactured by Mitsubishi Chemical Group Corporation) and a nonylphenol EO-modified acrylate (product name: M-113, manufactured by Toagosei Co., Ltd.).

Acrylic polymer 2: mixture obtained by mixing, at 60:40, urethane acrylate (product name: UN9000PEP, manufactured by Mitsubishi Chemical Group Corporation) and a nonylphenol EO-modified acrylate (product name: M-113, manufactured by Toagosei Co., Ltd.).

Acrylic polymer 3: mixture obtained by mixing, at 80:20, polyisoprene acrylate (product name: UC-203M, manufactured by Kuraray Co., Ltd.) and a nonylphenol EO-modified acrylate (product name: M-113, manufactured by Toagosei Co., Ltd.).

Light-transmitting member 1: member made of a polycarbonate (thickness 1 mm, refractive index 1.58, YI value <0.2, total light transmittance >95%, haze value <0.5%).

Light-transmitting member 2: member made of PET (thickness 1 mm, refractive index 1.57, YI value <0.5, total light transmittance >95%, haze value <0.5%).

Light-transmitting member 3: member made of methacrylic acid-styrene copolymer (thickness 1 mm, refractive index 1.56, YI value <0.5, total light transmittance >95%, haze value <0.5%).

TABLE 2

| | | | | EX. 1 | EX. 2 | EX. 3 | EX. 4 | EX. 5 |
|---|---|---|---|---|---|---|---|---|
| PHOTOCURABLE | PREPOLYMER 1 | | (PARTS BY MASS) | 100 | | | | |
| RESIN | PREPOLYMER 2 | | (PARTS BY MASS) | | 100 | | | |
| COMPOSITION | PREPOLYMER 3 | | (PARTS BY MASS) | | | 100 | | |
| | PREPOLYMER 4 | | (PARTS BY MASS) | | | | 100 | |
| | PREPOLYMER 5 | | (PARTS BY MASS) | | | | | 100 |
| | PREPOLYMER 6 | | (PARTS BY MASS) | | | | | |
| | PREPOLYMER 7 | | (PARTS BY MASS) | | | | | |
| | ACRYLIC POLYMER 1 | | (PARTS BY MASS) | | | | | |
| | ACRYLIC POLYMER 2 | | (PARTS BY MASS) | | | | | |
| | ACRYLIC POLYMER 3 | | (PARTS BY MASS) | | | | | |
| | PHOTOPOLYMERIZATION INITIATOR | | (PARTS BY MASS) | 0.05 | 0.05 | 1 | 0.05 | 0.05 |
| | COUPLING AGENT | | (PARTS BY MASS) | 0.45 | | | | |
| PHYSICAL | VISCOSITY | | (mPa · s/25° C.) | 150 | 500 | 500 | 5,000 | 40,000 |
| PROPERTIES | | | | | | | | |
| CURED PRODUCT | REFRACTIVE INDEX | | (—) | 1.55 | 1.55 | 1.56 | 1.57 | 1.57 |
| | ADHESIVE STRENGTH (WRT GLASS) | | (MPa) | 7 | 4 | 7 | 4 | 4 |
| | SHORE HARDNESS | | (—) | D-35 | D-35 | D-45 | A-37 | A-55 |
| | TOTAL LIGHT TRANSMITTANCE | | (%) | >99 | >99 | >99 | >99 | >99 |
| DISPLAY DEVICE | LIGHT-TRANSMITTING | REFRACTIVE | (—) | 1.58 | 1.58 | 1.58 | 1.58 | 1.58 |
| | MEMBER 1 | INDEX | | | | | | |
| | LIGHT-TRANSMITTING | REFRACTIVE | (—) | 1.57 | 1.57 | 1.57 | 1.57 | 1.57 |
| | MEMBER 2 | INDEX | | | | | | |
| | LIGHT-TRANSMITTING | REFRACTIVE | (—) | 1.56 | 1.56 | 1.56 | 1.56 | 1.56 |
| | MEMBER 3 | INDEX | | | | | | |

| | | | | | | | |
|---|---|---|---|---|---|---|---|
| EVALUATION | REFRACTIVE INDEX DIFFERENCE WITH | (—) | 0.03 | 0.03 | 0.02 | 0.01 | 0.01 |
| RESULT | LIGHT-TRANSMITTING MEMBER 1 | | | | | | |
| | REFRACTIVE INDEX DIFFERENCE WITH | (—) | 0.02 | 0.02 | 0.01 | 0 | 0 |
| | LIGHT-TRANSMITTING MEMBER 2 | | | | | | |
| | REFRACTIVE INDEX DIFFERENCE WITH | (—) | 0.01 | 0.01 | 0 | 0.01 | 0.01 |
| | LIGHT-TRANSMITTING MEMBER 3 | | | | | | |
| | OVERALL EVALUATION | (PASS/FAIL) | PASS | PASS | PASS | PASS | PASS |

| | | | | | | COMP. | COMP. | COMP. |
|---|---|---|---|---|---|---|---|---|
| | | | | EX. 6 | EX. 7 | EX. 1 | EX. 2 | EX. 3 |
| PHOTOCURABLE | PREPOLYMER 1 | | (PARTS BY MASS) | | | | | |
| RESIN | PREPOLYMER 2 | | (PARTS BY MASS) | | | | | |
| COMPOSITION | PREPOLYMER 3 | | (PARTS BY MASS) | | | | | |
| | PREPOLYMER 4 | | (PARTS BY MASS) | | | | | |
| | PREPOLYMER 5 | | (PARTS BY MASS) | | | | | |
| | PREPOLYMER 6 | | (PARTS BY MASS) | 100 | | | | |
| | PREPOLYMER 7 | | (PARTS BY MASS) | | 100 | | | |
| | ACRYLIC POLYMER 1 | | (PARTS BY MASS) | | | 100 | | |
| | ACRYLIC POLYMER 2 | | (PARTS BY MASS) | | | | 100 | |
| | ACRYLIC POLYMER 3 | | (PARTS BY MASS) | | | | | 100 |
| | PHOTOPOLYMERIZATION INITIATOR | | (PARTS BY MASS) | 0.05 | 1 | 3 | 7 | 10 |
| | COUPLING AGENT | | (PARTS BY MASS) | | | | | |
| PHYSICAL | VISCOSITY | | (mPa · s/25° C.) | 300 | 5,000 | 500 | 5,000 | 40,000 |
| PROPERTIES | | | | | | | | |
| CURED PRODUCT | REFRACTIVE INDEX | | (—) | 1.53 | 1.57 | 1.49 | 1.49 | 1.51 |
| | ADHESIVE STRENGTH (WRT GLASS) | | (MPa) | 8 | 5 | 20 | 15 | 8 |
| | SHORE HARDNESS | | (—) | A-18 | A-50 | D-76 | D-80 | D-55 |
| | TOTAL LIGHT TRANSMITTANCE | | (%) | >99 | >99 | >99 | >99 | >99 |
| DISPLAY DEVICE | LIGHT-TRANSMITTING | REFRACTIVE | (—) | 1.58 | 1.58 | 1.58 | 1.58 | 1.58 |
| | MEMBER 1 | INDEX | | | | | | |
| | LIGHT-TRANSMITTING | REFRACTIVE | (—) | 1.57 | 1.57 | 1.57 | 1.57 | 1.57 |
| | MEMBER 2 | INDEX | | | | | | |
| | LIGHT-TRANSMITTING | REFRACTIVE | (—) | 1.56 | 1.56 | 1.56 | 1.56 | 1.56 |
| | MEMBER 3 | INDEX | | | | | | |

| | | | | | | | |
|---|---|---|---|---|---|---|---|
| EVALUATION | REFRACTIVE INDEX DIFFERENCE WITH | (—) | 0.05 | 0.01 | 0.09 | 0.09 | 0.07 |
| RESULT | LIGHT-TRANSMITTING MEMBER 1 | | | | | | |
| | REFRACTIVE INDEX DIFFERENCE WITH | (—) | 0.04 | 0 | 0.08 | 0.08 | 0.06 |
| | LIGHT-TRANSMITTING MEMBER 2 | | | | | | |
| | REFRACTIVE INDEX DIFFERENCE WITH | (—) | 0.03 | 0.01 | 0.07 | 0.07 | 0.05 |
| | LIGHT-TRANSMITTING MEMBER 3 | | | | | | |
| | OVERALL EVALUATION | (PASS/FAIL) | PASS | PASS | FAIL | FAIL | FAIL |

As shown in Table 1, it can be understood that for the cured products obtained from the resin compositions of Examples 1-7, by adjusting the viscosity and constitution of the prepolymer, the refractive index of the cured product can be finely adjusted. Furthermore, for cured products of the resin composition according to the present embodiment, the difference in refractive indexes compared to light-transmitting members 1-3 was 0.05 or less in all cases. From the foregoing results, it can be understood that for the resin composition according to the present embodiment, by adjusting the refractive index more finely, it is possible to prepare a resin cured product layer having a small refractive index difference compared to various kinds of light-transmitting members.

### INDUSTRIAL APPLICABILITY

With the photocurable resin composition according to the present embodiment, by adjusting the refractive index more finely, it is possible to prepare a resin cured product layer having a small refractive index difference compared to various kinds of light-transmitting members, and therefore, the photocurable resin composition according to the present embodiment can be suitably used in a display device.

### REFERENCE SIGNS LIST

1: Display device
10: Image display member
20: Light-transmitting member
30: Resin cured product layer

1. A photocurable resin composition for a display device, the photocurable resin composition comprising: a prepolymer which is a reactant of a polyene and a polythiol and has in the structure thereof a carbon-carbon double bond and a mercapto group; and a photopolymerization initiator.

2. The photocurable resin composition for a display device according to claim 1, wherein the refractive index is 1.50-1.60 when cured under the following conditions:
(curing conditions)
the photocurable resin composition is poured into a formwork so as to have a thickness of 1 mm, and is then cured by being irradiated with light, using a light source having a central wavelength of 365 nm, so that the accumulated light amount is 3,000 mJ/cm² or more.

3. The photocurable resin composition for a display device according to claim 1, wherein the photocurable resin composition has a viscosity of 10-50,000 mPa·s/25° C.

4. A cured product of the photocurable resin composition for a display device according to claim 1.

5. A display device having laminated therein, in order, an image display member, a resin cured product layer, and a light-transmitting member,
the resin cured product layer being configured from a resin cured product comprising a reactant of a polyene and a polythiol.

6. The display device according to claim 5, wherein: the light-transmitting member is laminated directly on the resin cured product layer; and
a difference in refractive indexes between the resin cured product layer and the light-transmitting member is 0.05 or less.

7. The display device according to claim 5, wherein the resin cured product layer is configured from the cured product of the photocurable resin composition for a display device,
wherein the photocurable resin composition comprising: a prepolymer which is a reactant of a polyene and a polythiol and has in the structure thereof a carbon-carbon double bond and a mercapto group; and a photopolymerization initiator.

8. A laminated body provided with the cured product according to claim 4 and a light-transmitting member.

9. The laminated body according to claim 8, wherein the cured product is directly laminated on at least one surface of the light-transmitting member.

10. The laminated body according to claim 8, wherein a difference in refractive indexes between the light-transmitting member and the cured product is 0.05 or less.
